(19) United States
(12) Patent Application Publication
(10) Pub. No.: US 2005/0207195 A1
(43) Pub. Date: Sep. 22, 2005

(54) Apparatus and methods for regulating electric power

(76) Inventors: Carl O. Olsson, Canton Bern (CH); Richard Redl, Canton Fribourg (CH)

Correspondence Address: Carl O. Olsson, 25, Chemin d.Chenevieres, Evilard, CH 2533, CH

(21) Appl. No.: 10/805,200

(22) Filed: Mar. 22, 2004

(51) Int. Cl. H02M 1/00

(52) U.S. Cl. 363/125

(57) ABSTRACT

A regulated DC and/or AC power supply connected to an AC power source comprising an essentially loss free impedance followed by a controllable device that can sink essentially without losses a selected portion of the current from the essentially loss free impedance. The controllable device can, also essentially without loss, source current from its own internal storage so that the combined residual current can be made available to a load either as a regulated AC quasi square wave or, after rectification, as a regulated DC. A preferred embodiment is described in detail comprising a transformer with a considerable leakage inductance between its primary and secondary. An analog, alternatively a microprocessor-based controller, and a mosfet driver supply a mosfet rectifying bridge with proper gate voltages to obtain a regulated AC and/or DC output. In its simplest form the programmable device may be a generator with controllable phase and amplitude. In the preferred embodiment the mosfet rectifying bridge, having properly phased gate drives and an output storage capacitor, is able to both sink and source current whereby it can regulate its outputs AC and/or DC from zero to maximum. A solution is described to the problem of reducing any unwanted DC current in the transformer windings. A UPS version is described in the form of a push pull as well as a full rectifying bridge.

### FEDERAL SPONSORED RESEARCH

N.A.

### SEQUENCE LISTING OR PROGRAM

N.A.

### FIELD OF INVENTION

This invention relates to Interruptible and Uninterruptible Power Supplies (UPS) using conversion by approximately mains frequency and normally sourcing from the mains. In the UPS configuration an apparatus designed according to our methods converts power from a battery or other standby power source into an unregulated quasi square wave AC output suitable for Cable TV amplifiers.

### PRIOR ART

Prior Art follows from the enclosed reference list and includes ferroresonant transformer designs with or without saturating iron cores. Saturating cores produce considerable acoustical noise, have low efficiency and develop much heat. Simulation techniques to avoid saturation use abruptly switching devices, causing voltage spikes, which disturb other sensitive circuits. Some techniques involve more than one airgap which adds to the cost. Furthermore, when a quasi square wave is desired from such a circuit its waveform is far from having the flat top that is normally required.

Mains frequency dependence, difficulty to regulate the output voltage down to zero, big volume and heavy weight are other drawbacks.

High frequency switching power supplies suffer from emission of HF noise. The need to make very compact transformers makes it difficult and expensive to provide a strong isolation between primary and secondary. This aggravates the influence of noise and destructive transients from the mains and prevents allowing a high voltage difference between primary and secondary.

### OBJECTS AND ADVANTAGES

Compared to ferroresonant types our methods offer much better regulation, lower volume and weight, tolerance to mains frequency deviations, hardly any acoustical noise and excellent efficiency. Another most important advantage is that an output voltage or current can be adjusted from maximum down to zero for a DC and, in the case of an AC output voltage or current, down to a very low value.

Compared to switching power supplies our methods offer very low noise emission and the option to allow a high voltage difference between the power source and the output. Compared to RANDALL (1971) our solution offers a UPS version and the combination of mosfet transistors with a suitable control circuit.

### SUMMARY

A regulated power supply connected to an AC frequency power source comprising an essentially loss-free impedance followed by a controllable device which is controlled by a control circuit in such a way as to be able to sink or source current in an essentially loss-free manner. The load is connected across the controllable device. The control circuit controls the controllable device so that the voltage or current into the load is regulated as needed. A method is described how to add means to obtain uninterruptible operation, UPS.

### DRAWING FIGURES

FIG. 1A shows an AC power source connected to a load via an essentially loss free inductor, the load being in parallel with a controllable device.

FIG. 1B shows the same but with the inductor replaced by a capacitor.

FIG. 2 shows the controllable device in the shape of a mosfet rectifying bridge connected to a filter capacitor.

FIG. 3A shows a block diagram with a control circuit and a mosfet drive circuit.

FIG. 3B shows an oscillator inserted between the control circuit and the drive circuit.

FIG. 4 shows a transformer with high leakage between primary and one secondary.

FIG. 5 shows the rectifying bridge with amplifiers for current control and DC elimination.

FIG. 6 shows the same but with a simpler way of achieving DC elimination.

FIG. 7 shows the wave form used for timing the mosfet bridge.

FIG. 8A shows a part of the detailed diagram of the control circuit.

FIG. 8B shows the rest of the detailed diagram of the control circuit.

FIG. 9 shows an embodiment with two mosfets in push pull.

The rectifiers can be any controllable electronic valves but mosfet transistors are preferred and are used as controlled rectifiers. When turned on they conduct current in both directions. When turned off only the body diode conducts in one direction except for a small leakage in the opposite direction. The transition between the blocked and the conducting state can be easily controlled to obtain slower and less noisy transitions.

### DETAILED DESCRIPTION

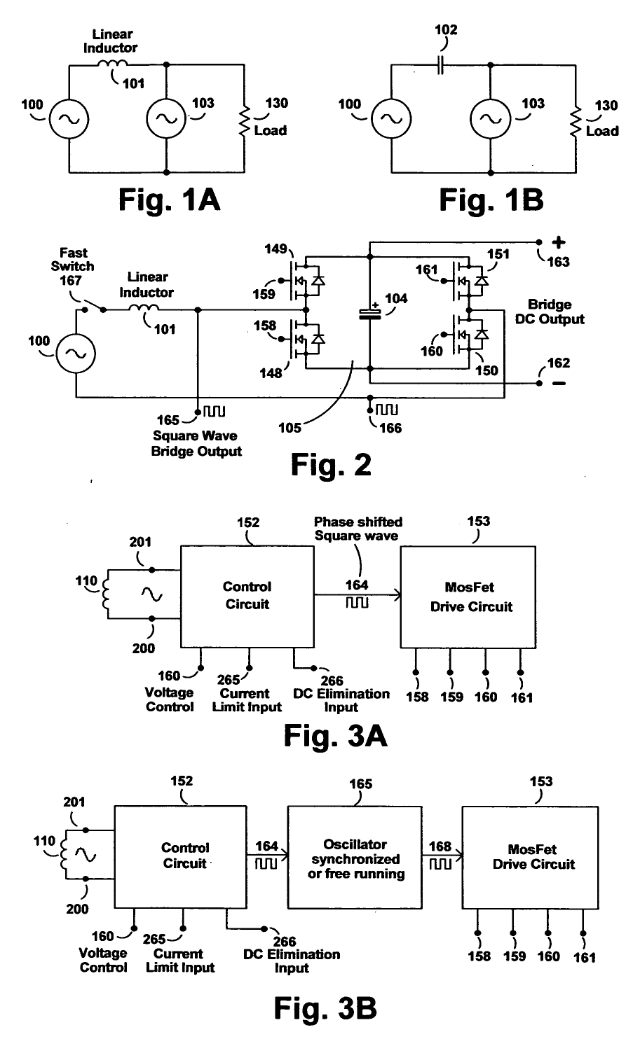

The methods can be understood from FIGS. 1A and B. An AC source 100 is connected to an essentially loss free linear inductor 101, FIG. 1A, in series with an essentially loss free controllable device 103 which can both sink and source currents. Alternatively, in FIG. 1B, the inductor is replaced by a capacitor 102. Due to the nature of capacitors this alternative is only practical when the source delivers a voltage that is essentially a sine wave and the controllable device sinks or sources a current that is essentially a sine wave. A load 130 is connected across the controllable device 103. The controllable device can be controlled so that the voltage to the load 130 can be adjusted from minimum to maximum.

In the simplest form the power source is the mains with sinusoidal waveform and the controllable device is an AC generator, the phase and current of which can be controlled so as to make a regulated voltage appear across the load. In FIG. 2 the preferred embodiment of our methods shows the controllable device as a regulating mosfet bridge 105 connected to a storage capacitor 104 as shown in FIGS. 2, 5, 6 and 9. The regulating bridge 105 in FIG. 2 can be controlled by a control circuit 152 and a mosfet driver 153. The storage function of the capacitor 104 enables the regulating bridge 105 to both source and sink current. Proper gate timing of the mosfets results in a regulation of the AC voltage across the bridge 105 and the DC voltage across the capacitor 104.

The storage function could also be supplied by a battery or even a rotating electric machine with inertia and an inherent electromotive force. The AC current through the capacitor 104 results in a ripple voltage.

In FIG. 3A the control circuit 152 turns the input reference voltage 110 into a phase shifted square wave 164. This is used in FIG. 2 to activate the mosfet drive circuit 153 with proper timing to drive the four mosfets 148-151 in the regulating bridge 105. The mosfet drive circuit 153 has four outputs with the same numbers 158-161 as the corresponding mosfet gate numbers. It is a standard item and will not be described here.

The AC voltage across the regulating bridge 105 is a good square wave. Obviously, a square wave cannot fully compensate a sinusoidal current through inductor 101 or capacitor 102, so the residual will add to the ripple across capacitor 104.

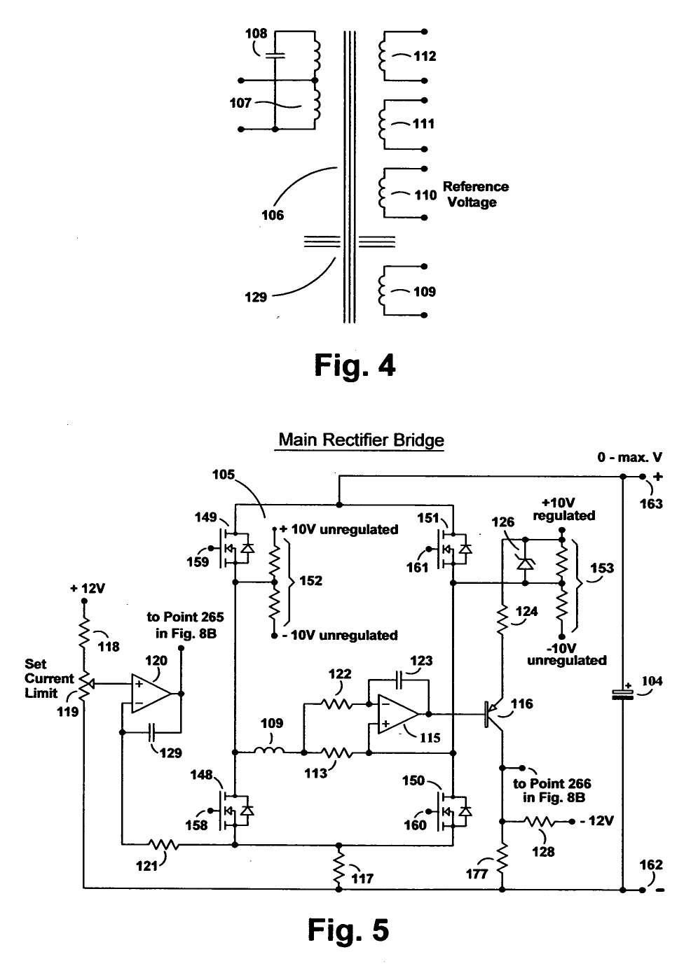

The control circuit 152 has inputs for voltage control 160 and current control 265. As it is often desirable to separate the source from the load galvanically a transformer may be connected in between. The linear inductor 101 is then inserted either in the primary or secondary or split in two with one part in each. The control circuit 152 has one input 266 to reduce to safe value any unwanted DC current in a transformer winding 109 in FIG. 4. The analog control circuit 152 can be replaced by a microprocessor. A microprocessor can carry out the several tasks of the analog control circuit 152 and in addition facilitate computer control.

### The Preferred Embodiment

of our methods is to use a transformer 106 with a considerable leakage inductance between primary and secondary as in FIG. 4. This leakage inductance will serve as the linear inductor 101. The design of such a transformer is similar but not equal to the designs common in ferroresonant transformers, the difference mainly being that the full winding space can be used for primary and secondary except for the airgap 129 in between and that no space is wasted on the resonant winding. The transformer 106 in FIG. 4. has an extra tap on the primary for a capacitor 108 for Power Factor Correction and improved efficiency. There is at least one secondary 109 to deliver the output power. A plurality of other secondaries for instance 110, 111, 112 or more, are close to the primary, and used for time reference and auxiliary voltages. Alternatively, a separate low power transformer can be used for such voltages. A typical size is 1-2 watts.

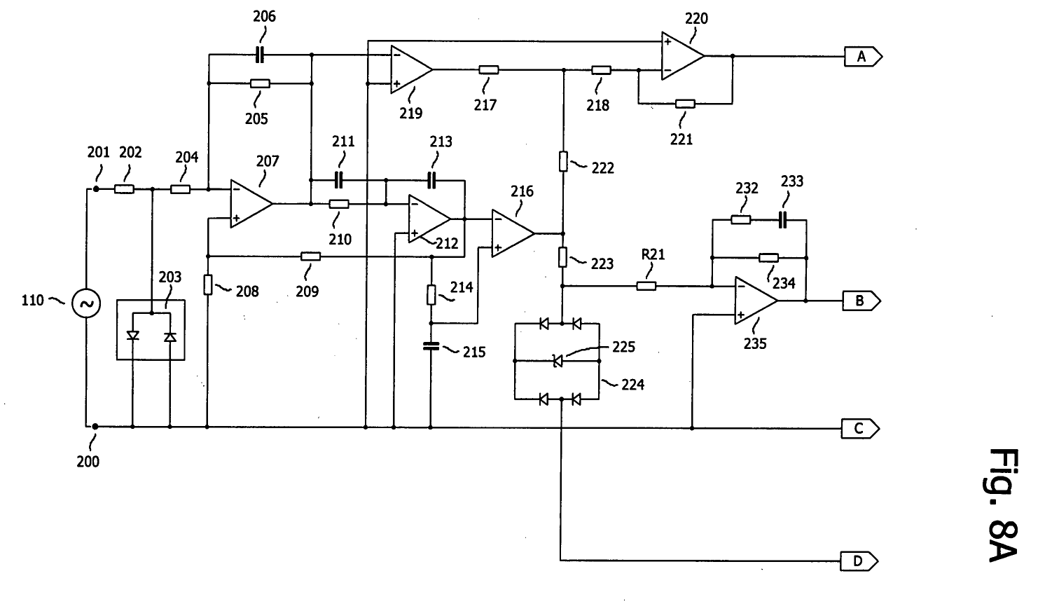

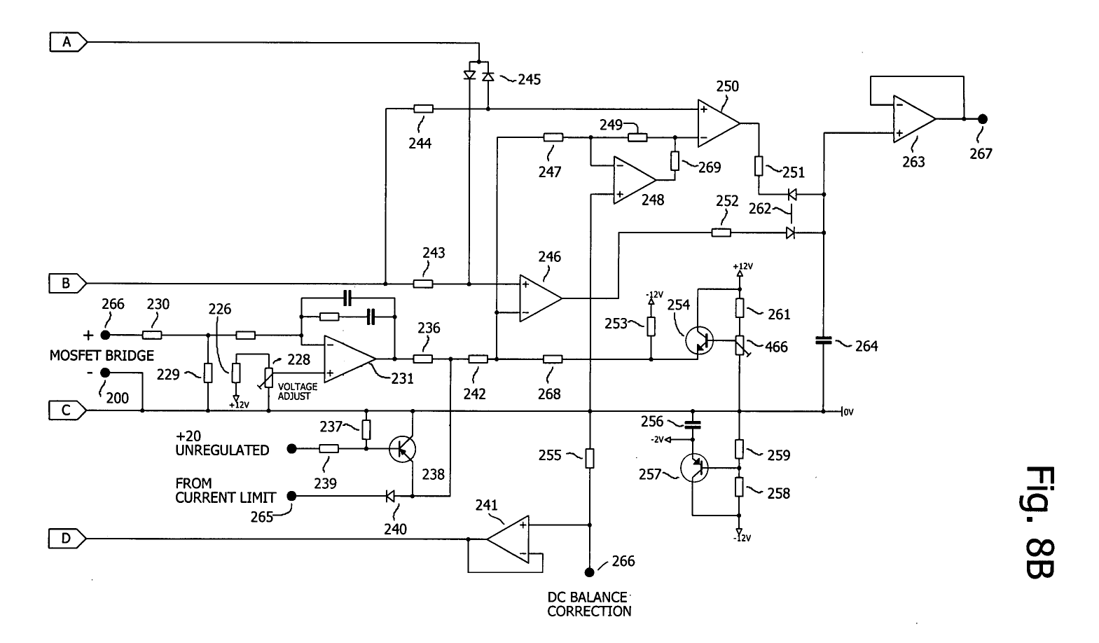

In FIG. 5 the winding 109 is connected to the bridge 105 in series with a small resistor 113 of typically a few milliohms for the purpose of detecting nonacceptable DC current through the winding 109. The output of the bridge 105 is connected to a capacitor 104 in series with a small resistor 117. The capacitor 104 should be of sufficient size to reduce the ripple voltage to an acceptable value. The small resistor 117 is used for current regulation. The voltage in the millivolt range across resistor 117 is compared to the setting of a current limit potentiometer 119 by an amplifier 120. The output of amplifier 120 goes to point 265 and diode 240 in FIG. 8B and will override the voltage control amplifier 231 when the set current limit is exceeded.

The possibility of a DC core saturation of transformer 106 in FIG. 4 due to inequalities among the mosfets in bridge 105 in FIG. 5 is a very serious consideration and may, if uncorrected, leads to overheating and eventual destruction of the power supply.

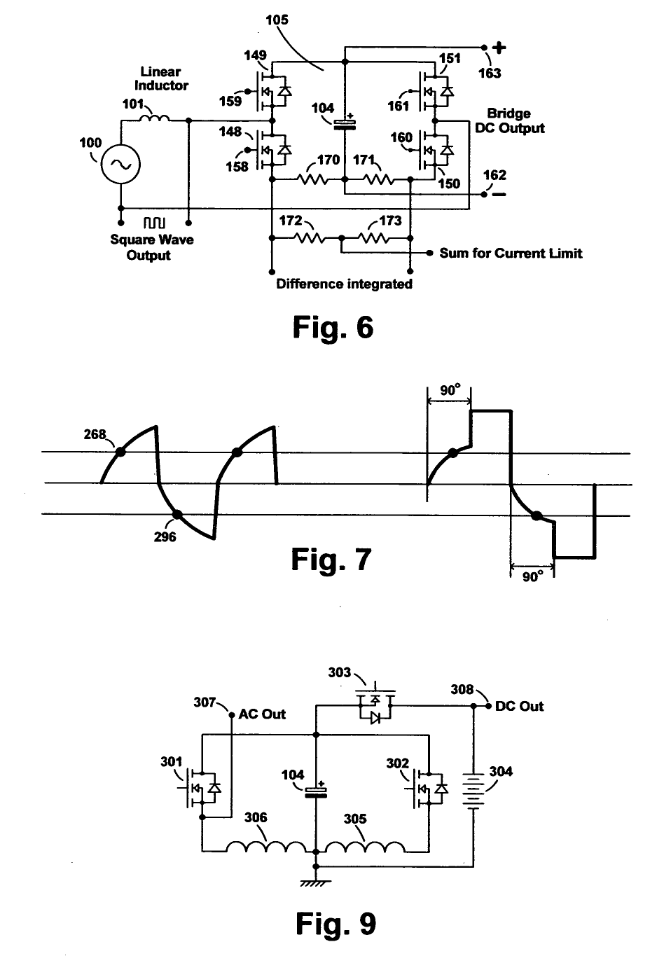

FIG. 6 shows an approximate solution arranged by integrating the difference between the DC currents through the left and the right legs of the bridge by the use of two small equal resistors 170 and 171. This requires a mains voltage with perfect symmetry between the positive and negative half cycles.

The sum of the two small voltages obtained by resistors 172 and 173 may be used for the current limit regulation by comparing their half sum with the tap voltage of potentiometer 119. This potentiometer and the amplifier 120 are used for regulating the current limit.

FIG. 5 shows a more accurate method by integrating the actual DC current through the secondary 109. The resistor 113 and the integrating amplifier 115 with components 122 and 123 will detect and integrate any DC current in the winding 109 and then transfer the result by transistor 116 to the system ground and the input 266 of amplifier 241 in FIG. 8B. The low impedance output of amplifier 241 is used to adjust the potential of the diode bridge 224. This adjustment will influence the relation between the positive and negative half cycles of the square wave at the output 267 of amplifier 263 in such a direction as to reduce the dangerous DC current in winding 109 to an acceptable limit.

FIG. 5 shows that mosfets 149 and 151 have each a floating power supply 152 and 153 of typically plus and minus 5-10 Volts to source the power to control the gates. The positive side of supply 153 is regulated by zener diode 126 so that the emitter current in transistor 116 is more independent of mains voltage fluctuations.

### Other Embodiments

There may be a plurality of secondaries intended for low or high DC voltages and AC square waves voltages, the important matter being that one or more of these secondaries is running a regulating bridge and is big enough to handle the AC current needed for regulation.

Other numbers of mosfets may be used such as two in a push-pull configuration or a plurality for multiphase operations. The AC square wave voltage obtained is eminently suited for use in Cable TV power systems as it is well regulated and has a better flat top than designs based on unregulated ferroresonant transformers. The square wave voltage is by means of a power inserter injected into a coaxial cable or into a separate cable and rectified at the client's premises and used to power amplifiers. Accurate regulation of the amplitude of the square wave voltage is not necessary but it is an advantage if the top is flat because the rectification is then more efficient.

In Cable TV systems requiring uninterruptible service our methods can also be used. Referring to FIG. 3B a simple free running oscillator 165 is placed between the control circuit and the mosfet drivers, or at any other suitable location. The oscillator has a frequency a few percent below the mains frequency. In normal operation the oscillator is synchronized by the square wave 164 and produces a phaseshifted output 168. If the mains drops out the fast switch 167 in FIG. 2 disconnects the mains and the oscillator will continue to run at its own slightly lower frequency and produce a square wave voltage 168 as before. The power supply will then continue to supply a now unregulated AC square wave voltage still well suitable to power the Cable TV Amplifiers. When the mains returns fast switch 167 reconnects to the mains after synchronization according to well established technologies. In this embodiment all auxiliary voltages are supplied by AC power from the regulating bridge and a separate link keeps contact with the mains to detect state and phase so that reconnection can occur at the proper moment.

A push pull configuration for Cable TV UPS use is shown in FIG. 9. The transformer secondary has two parts 305 and 306 which are connected to two mosfets 301 and 302. The gates of these mosfets are given a suitably timed square wave voltage so that current can be sunk and sourced from storage capacitor 104. The DC voltage across capacitor 104 is connected via the mosfet 303 to a float charged battery 304. With the mains present mosfet 303 is turned off, its body diode serving to prevent the AC ripple voltage from sending negative pulses through the float charged battery 304. With the mains off mosfet 303 is turned on and allows the battery 304 to drive the push pull circuit so that AC power continues to be available from point 307. An advantage with this method is that DC and AC power may have a common system ground

### Detailed Description of Control Circuit 152

FIGS. 8A and 8B show in detail the circuit diagram of the control circuit 152. The voltage from the reference winding 110 supplies the timing reference over the terminals 200 and 201, the resistor 202 and the double diode 203. The quasi square wave from the diodes 203 is integrated first by the integrating amplifier 207 with resistors 204, 205 and capacitor 206, and secondly by integrator 212 with resistors 208, 209 and 210, and capacitors 211 and 213. The output of integrator 212 is turned into a square wave by amplifier 216 and reduced in amplitude by resistor 223 and diode bridge 224 with zener diode 225. This square wave is approximately 180 degrees later than the reference voltage.

A DC offset from the integrators and from differences in the two diodes 203 is compensated by DC feedback via resistor 214 and capacitor 215. The purpose of the two integrations by amplifiers 207 and 213 is to reduce false timing signals from mains transients and together with amplifier 216 provide a square wave which is largely independent of the mains frequency. Further integrations may be added for increased reduction of false time signals but must obviously be in even numbers so that a multiple of 180 degrees is obtained.

Extra separation from the mains, if desired, may call for an optocoupler between the reference winding and the rest of the circuit.

The square wave voltage drives a waveform generator, amplifier 235, which produces a positive rising voltage during the negative half cycle of the square wave from bridge 224 and a mirror shaped falling voltage during the positive half cycle. These wave forms are shown in FIG. 7. They are used to provide timing pulses when intersecting with the positive output of Voltage Regulating Amplifier 231 via resistors 236 and 242 and its inverted negative output via the inverter, amplifier 248. Using both half cycles means that regulation can be faster than if only one timing signal per cycle had been used. The positive rising half cycle from amplifier 235 is compared with the positive output of a voltage regulating amplifier 231 by comparator 246. When exceeding this positive output it causes comparator 246's output to go high. Going high it charges capacitor 264 through the lower of the two diodes 262. The diode enables the capacitor to maintain its voltage when the comparator goes low again at the end of the half cycle.

In the same way comparator 250 goes low when the negative falling wave crosses the inverted output of amplifier 231. The upper diode 262 now reverses the charge of capacitor 264, and this charge is maintained until the positive wave again crosses the positive output of amplifier 231, and so on. The result is a phase shifted high impedance square wave which is given a low impedance output by amplifier 263 and which can be used to steer the mosfet bridge 105 via the mosfet drive circuit 153 to obtain the required regulation.

However, to prevent these timing signals from arriving outside the allowed operating range of delays of between 0 and 90 degrees, the output of amplifier 207 is used. This output is approximately 90 degrees later than the time reference. It is fed to amplifiers 219 and 220 and diodes 245 to abruptly expand the rising and falling voltages at about 90 degrees. This way the signal from amplifier 231 and its inverted value will not be able to reach points beyond 90 degrees. Thus no timing pulses beyond 90 degrees are possible. The voltage divider, resistor 226, and potentiometer, 228, feeds a part of a DC reference voltage to the noninverting input of amplifier 231. Another voltage divider feeds a part of the DC output voltage of the power supply to the inverting input of the amplifier 231. This causes the amplifier 231 to react in such a direction as to try to maintain a desired output voltage as set by potentiometer 228. Amplifier 231 can be overridden by the Current Limit Amplifier 120 in FIG. 5 through a connecting diode 240. If the current limit reference is exceeded then amplifier 120 overrides amplifier 231 and takes over the phase angle control and determines the current limit as desired.

Proper operation demands that the output of amplifier 231 be further limited in the negative direction by transistor 254 and in the positive direction by transistor 238. The negative limit serves to clear tolerances in the exact beginning of the waveform from amplifier 235. The limit imposed by transistor 238 is approximately proportional to the mains voltage. It is derived from an unregulated point of an auxiliary voltage, typically about 20 V DC. Experience from models has shown that without this precaution abnormally low mains voltages, such as brown outs, could cause high spikes from the leakage inductance that could destroy the mosfets.

1. A power supply connected to an AC, Alternating Current, power source of arbitrary waveform comprising:
a. an essentially loss free impedance in series with
b. a controllable essentially loss free electronic device with means to both sink and source AC current of an arbitrary waveform,
c. means of controlling said electronic device,
d. a load connected in parallel with said electronic device whereby the power supplied to said load is regulated as desired.

2. A power supply as recited in claim 1 in which the essentially loss free impedance is an inductor.

3. A power supply as recited in claim 1 in which the essentially loss free impedance is a capacitor but the source voltage and current are sine waves.

4. A power supply as recited in claim 2 comprising a transformer connected to the mains and said inductor included in its primary or secondary circuits or both, or said inductor consisting of a considerable leakage inductance between the primary and at least one secondary, said load being distributed between said secondaries as needed.

5. A power supply as recited in claim 4 in which the voltage from at least one secondary is rectified by controllable valves and the charge stored in a capacitor, said valves being turned on and off by timing signals from an analog control circuit or a microprocessor so that said secondary performs as said essentially loss free electronic device being able to both sink and source current whereby the control circuit regulates the AC voltage across said secondary within a wide range.

6. A power supply as recited in claim 5 in which a load is also connected in parallel with said capacitor, and in which the DC, Direct Current, voltage across said capacitor and the current to said load are compared to DC reference voltages and regulated by feed back means whereby regulated and adjustable DC voltage and current from zero to maximum is available and AC regulated and adjustable voltage and current from a low value to maximum is available and the respective proportions of DC and AC power selectable as needed.

7. A power supply as recited in claim 6 in which the transformer has a plurality of secondaries, some intended for AC and some to provide DC whereby one DC unit is providing regulation and adjustment causing the others to follow and be regulated and adjusted as well.

8. A power supply as recited in claim 7 in which the controllable valves are mosfets with their switching speed reduced whereby a minimum of noise is caused.

9. A power supply as recited in claim 8 in which the timing sinusoidal signal is reduced to a semi square wave and integrated an even number of times to obtain a delay of 180° or a multiple thereof whereby a resulting timing signal will be less influenced by noise from the mains.

10. A power supply as recited in claim 9 in which the resulting time signal has means to create a positive rising waveform comprising approximately 180° and a mirrorlike falling waveform comprising the following 180° so that two timing pulses are available during each cycle.

11. A power supply as recited in claim 10 which has means to limit the timing delay to the first 90° of each half cycle.

12. A power supply as recited in claim 11 with means to further limit the range of delay whereby safeguarding against a too low mains voltage.

13. A power supply as recited in claim 12 having means to detect and eliminate down to an acceptable level DC current in the transformer windings whereby preventing saturation of the transformer and destruction of the power supply.

14. A power supply as recited in claim 13 adapted to uninterruptible service by including an oscillator with slightly lower frequency than the mains, a first fast switch to connect and disconnect the mains, a second fast switch to connect and disconnect a battery or other standby power source, and means to operate said switches at the correct times whereby the power supply will automatically switch to standby power in the event of a mains failure and go back to normal operation when the mains returns, the DC voltage from said capacitor being used to recharge the battery if any.

15. A power supply as recited in claim 14 in which four mosfets are used in a bridge whereby the voltage across each mosfet is limited to essentially the DC output voltage.

16. A power supply as recited in claim 15 in which two mosfets are used in a push pull configuration whereby the AC and DC outputs can use the same system ground and the voltage across each mosfet is approximately double the DC voltage.

17. A method of regulating an AC voltage comprising the steps of:
a. supplying an AC utility power having a line frequency;
b. connecting it to a load in series with an inductor;
c. connecting a controllable device in parallel with the load said controllable device being able to essentially loss-free sink and source current;
d. connecting a controller to said controllable device said controller steering the phase and amplitude of the current from and to the controllable device whereby the voltage across the load can be adjusted and regulated.

18. A method of regulating a DC voltage as described in claim 17, wherein said voltage across the regulating device is rectified by mosfet rectifiers and is charging a capacitor in parallel with the load, said controller to be using feed back methods and turning on and turning off the mosfets so that said capacitor is sourcing or sinking current whereby the DC voltage across the capacitor is being controlled and regulated.

19. A method as described in claim 18 supplying simultaneously both regulated and controlled AC and DC

20. A method as described in claim 19 wherein said capacitor is connected with a battery or other DC supply through a mosfet transistor, said controller including an oscillator normally synchronized with the mains but having a slightly lower natural frequency than the mains and driving the mosfet rectifiers also when the mains has dropped out and using the power from the battery or other DC supply whereby the operation is continuing uninterrupted.
